(19) United States
(12) Patent Application Publication
(10) Pub. No.: US 2008/0147375 A1
(43) Pub. Date: Jun. 19, 2008

(54) SYSTEM, METHOD, DEVICE, AND COMPUTER PROGRAM PRODUCT FOR PROVIDING A PORTABLE DEVICE HAVING DRIVE EMULATION CAPABILITIES

(75) Inventors: Janne Siren, Lempaala (FI); Reijo Gratseff, Pirkkala (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/613,037

(22) Filed: Dec. 19, 2006

(51) Int. Cl. G06F 9/455; G06F 13/20

(52) U.S. Cl. 703/24; 710/300

(57) ABSTRACT

Systems, methods, devices, and computer program products provide a portable electronic device configured to be communicatively coupled to a host device and configured to emulate one or more data storage medium drives, such as disk drives, of the host device. More particularly, a user interface of the portable electronic device may allow a user to instruct the portable electronic device to emulate a particular type of drive, such as a floppy drive, a CD drive, and a DVD drive, and to present data storage medium image files to the host device in the emulated drive. The systems, methods, devices, and computer products may also be configured to automatically present a second data storage medium image file to the host device in response to an eject request from the host device.

### FIELD OF EMBODIMENTS OF THE INVENTION

Embodiments of the invention relate generally to systems for emulating disk drives and for presenting disk images. More particularly, embodiments of the invention relate to systems, methods, devices, and computer program products for providing a portable disk emulation device.

### BACKGROUND OF EMBODIMENTS OF THE INVENTION

With the many different types of data storage medium that have been popular at various times over the years, many people have a wide variety of data storage medium that they must keep track of, such as floppy disks, CDs (Compact Disks), DVDs (Digital Versatile Disks), BDs (Blu-ray Disks), and other types of data storage media. If a user desires to utilize these devices in other computers, the user must carry around the actual disks. Although a user may be able to copy the contents of some disks to a removable hard drive and carry this around instead the disks, many disks, such as installation disks and gaming disks, contain software applications where the user is required to run the program from the a local disk drive of the computer.

For example, when a network administrator is installing or updating firmware of a plurality of network computers, the installation or update often requires that the administrator use the actual disks in a particular local disk drive of the computer. Installations and updates also typically require the administrator to swap disks in the disk drive at least once during the installation or update. In addition to it being cumbersome for the administrator to carry all of the disks with him or her, the administrator may also damage or lose the disks if forced to carry them from computer to computer. Furthermore, if a computer does not have the right type of disk drive to read a certain type of disk, then the administrator may have a particularly hard time loading the software to the computer. As a result, the administrator may also have to carry around a plurality of external disk drives. Therefore, it would be advantageous if a system existed where a user, such as a network administrator, could more easily carry around a plurality of storage devices.

### BRIEF SUMMARY OF EMBODIMENTS OF THE INVENTION

Therefore, embodiments of the present invention provide a portable electronic device configured to be coupled to a host device and configured to emulate one or more data storage medium drives, such as disk drives, of the host device. More particularly, a user interface of the portable electronic device may allow a user to instruct the portable electronic device to emulate a particular type of drive, such as a floppy drive, a CD drive, and a DVD drive, and to present data storage medium image files to the host device in the emulated drive. Embodiments of the present invention may also be configured to automatically present a second data storage medium image file to the host device in response to an eject request from the host device.

In one embodiment a portable electronic device is provided. The device includes a memory for storing a data storage medium image file, the data storage medium image file comprising a copy of content and structure of a data storage medium. The device further includes a user interface for allowing a user to enter user input; a data communication interface for coupling the portable electronic device to a host device; and a processor operatively coupled to the memory, the user interface, and the data communication interface. The processor is configured to provide the host device with a virtual data storage medium drive that allows the host device to access the data storage medium image file. The processor may also be configured to provide the virtual data storage medium drive when the user input instructs the processor to do so.

The processor may be further configured to provide at least two types of virtual data storage medium drives, and to provide one of the at least two types based on the user input. The types of virtual data storage medium drives may include a floppy disk drive, a CD-ROM drive, a CD-R/RW drive, a DVD drive, a DVD±R drive, a DVD±RW drive, or the like. Where the memory is configured to store at least two types of data storage medium image files, the user input interface may be configured to allow the user to select a data storage medium image file, and the processor may provide the one of the at least two types of virtual data storage medium drives based on the type of the selected data storage medium image file.

The user input interface may be configured to allow the user to select a data storage medium image file stored in the memory for presentation to the host device. The processor may be configured to provide the virtual data storage medium drive when the user selects the data storage medium image file for presentation to the host device.

The memory may have a virtual driver stored therein, and the processor may be configured to provide the virtual data storage medium drive by executing the virtual driver. The processor executing the driver may be configured to allow the host device to access the data storage medium image file in the same way that the host device would access a data storage medium in a non-virtual data storage medium drive.

The processor may be configured to receive an ejection request from the host device and may be configured to provide a response to the host device that a data storage medium has been ejected. In one embodiment, where the user input comprises a selection of a first data storage medium image file and a second data storage medium image file stored in the memory, the processor may be configured to first present the first data storage medium image file to the host device as being in the virtual data storage medium drive. Then, in response to the ejection request from the host device, the processor may be further configured to cease presenting the first data storage medium image file as being in the virtual data storage medium drive and automatically commence presenting of the second data storage medium image file in the virtual data storage medium drive.

The data communication interface of the portable electronic device may include a USB port for coupling the portable electronic device to the host device. The portable electronic device may be a mobile telephone.

In another embodiment of the present invention, a computer program product is provided for emulating a data storage medium drive of a host device on a portable electronic device when the portable electronic device is operatively coupled to the host device. The computer program product includes at least one computer-readable storage medium having computer-readable program code portions stored therein. The computer-readable program code portions may include: a first executable portion for receiving user input comprising an indication that a virtual data storage medium drive should be provided to the host device; and a second executable portion for providing the host device with the virtual data storage medium drive and for presenting a data storage medium image file to the host device in the virtual data storage medium drive. The data storage medium image file comprises a copy of content and structure of a data storage medium. The second executable portion may be configured to provide the virtual data storage medium drive based on the user input received by the first executable portion.

In another embodiment of the present invention, a method is provided of using a portable electronic device to emulate a data storage medium drive of a host device. The method comprises: receiving, at the portable electronic device, user input comprising an indication that a virtual data storage medium drive should be provided to the host device; providing the host device with a virtual data storage medium drive based on the user input received by the first executable portion; and presenting a data storage medium image file to the host device in the virtual data storage medium drive, where the data storage medium image file comprises a copy of content and structure of a data storage medium.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic block diagram of a portable electronic device in accordance with one embodiment of the present invention;

FIG. 2 is a schematic diagram illustrating a portable electronic device coupled to a host device in accordance with one embodiment of the present invention;

FIG. 3 is a flowchart of a method of presenting a selected data storage medium image file to a host device in accordance with one embodiment of the present invention; and

FIG. 4 is a flowchart of a method of presenting more than one selected data storage medium image file in accordance with one embodiment of the present invention.

### DETAILED DESCRIPTION OF EMBODIMENTS OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. Like numbers refer to like elements throughout.

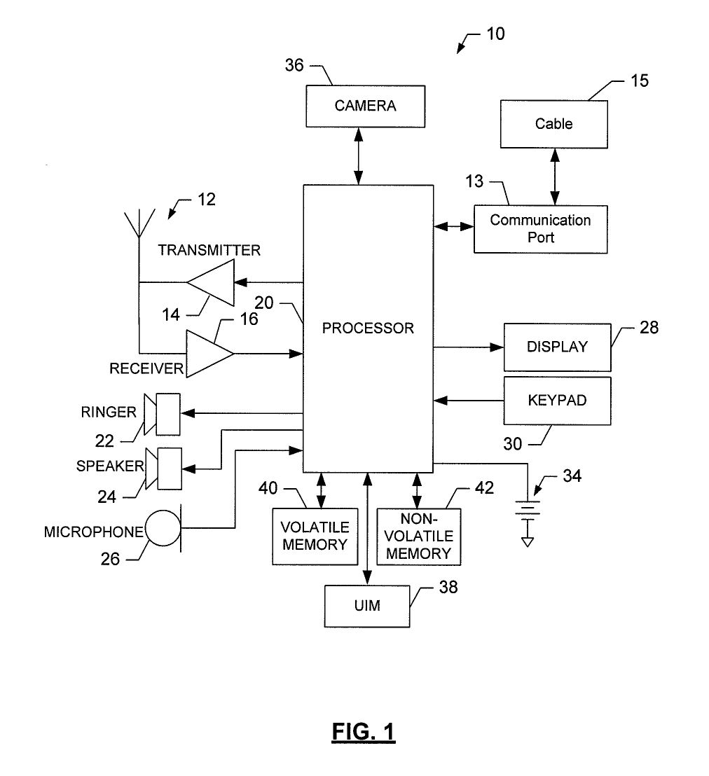

FIG. 1 illustrates a block diagram of a portable electronic device 10, according to one embodiment of the present invention. Although FIG. 1 illustrates a mobile telephone as the portable electronic device, it should be understood that a mobile telephone is merely illustrative of one type of portable electronic device that could be used with embodiments of the present invention. While several embodiments of the portable electronic device 10 are illustrated and will be hereinafter described for purposes of example, other types of portable electronic devices, such as digital cameras, portable digital assistants (PDAs), pagers, mobile televisions or video players, mobile computers, laptop computers, mp3 players, satellite radio units, mobile video game consoles, and other types of systems that manipulate and/or store data files, can readily employ embodiments of the present invention.

The portable electronic device 10 includes a communication interface comprising an antenna 12 in operable communication with a transmitter 14 and a receiver 16. The portable electronic device 10 further includes a processor 20 or other processing element that provides signals to and receives signals from the transmitter 14 and receiver 16, respectively. The signals include signaling information in accordance with the air interface standard of the applicable cellular system, and also user speech and/or user generated data. In this regard, the portable electronic device 10 is capable of operating with one or more air interface standards, communication protocols, modulation types, and access types. By way of illustration, the portable electronic device 10 is capable of operating in accordance with any of a number of first, second and/or third-generation communication protocols or the like. For example, the portable electronic device 10 may be capable of operating in accordance with second-generation (2G) wireless communication protocols IS-136 (TDMA), GSM, and IS-95 (CDMA) or third-generation wireless communication protocol Wideband Code Division Multiple Access (WCDMA).

The portable electronic device 10 also includes a communication interface comprising a communication port 13 configured to be permanently or removably connected to a cable 15 that can be used to connect the portable electronic device 10 to other electronic devices. The processor 20 may provide signals to and receive signals from the communication port 13. The portable electronic device 10 may be configured to use the communication port 13 and the cable 15 to communicate with other electronic devices. The portable electronic device 10 and the cable 15 may be structured so that data and/or power may be communicated between the portable electronic device 10 and the other electronic device. For example, in one embodiment, the cable 15 comprises a Universal Serial Bus (USB) cable having data wires, a power wire, and a ground wire. Power received through the cable 15 may be used by the portable electronic device 10 to power various components of the device and/or charge a battery 34.

It is understood that the processor 20 includes circuitry required for implementing audio and logic functions of the portable electronic device 10. For example, the processor 20 may be comprised of a digital signal processor device, a microprocessor device, and various analog to digital converters, digital to analog converters, and other support circuits. Control and signal processing functions of the portable electronic device 10 are allocated between these devices according to their respective capabilities. The processor 20 thus may also include the functionality to convolutionally encode and interleave message and data prior to modulation and transmission. The processor 20 can additionally include an internal voice coder, and may include an internal data modem. Further, the processor 20 may include functionality to operate one or more software programs, which may be stored in memory. For example, the processor 20 may be capable of operating a connectivity program, such as a conventional Web browser. The connectivity program may then allow the portable electronic device 10 to transmit and receive Web content, such as location-based content, according to a Wireless Application Protocol (WAP), for example.

The portable electronic device 10 also comprises a user interface including an output device such as a conventional earphone or speaker 24, a ringer 22, a microphone 26, a display 28, and a user input interface, all of which are coupled to the processor 20. The user input interface, which allows the portable electronic device 10 to receive data, may include any of a number of devices allowing the portable electronic device 10 to receive data, such as a keypad 30, a touch display (not shown) or other input device. In embodiments including the keypad 30, the keypad 30 may include the conventional numeric (0-9) and related keys (#, *), and other keys used for operating the portable electronic device 10. Alternatively, the keypad 30 may include a conventional QWERTY keypad. The portable electronic device 10 further includes a battery 34, such as a vibrating battery pack, for powering various circuits that are required to operate the portable electronic device 10, as well as optionally providing mechanical vibration as a detectable output.

In one embodiment, the portable electronic device 10 includes a headset (not shown). The headset may comprise a speaker and/or a microphone that may be used in addition to or as an alternative to speaker 24 and microphone 26. The headset may be wired to the portable electronic device 10 or the headset may be configured to wirelessly communicate with the portable electronic device 10 through one of the portable electronic device's communication interfaces. In one embodiment, the portable electronic device may use Bluetooth® wireless technology to communicate with the wireless headset. Bluetooth® is an open radio-frequency standard that enables cable-free voice and data communication between devices through short-range two-way radio (in the radio frequency range of 2.45 gigahertz).

In an exemplary embodiment, the portable electronic device 10 includes a camera 36 in communication with the processor 20. The camera 36 may be any means for capturing an image for storage, display or transmission. For example, the camera 36 may include a digital camera capable of forming a digital image file from a captured image. As such, the camera 36 includes all hardware, such as a lens or other optical device, and software necessary for creating a digital image file from a captured image. Alternatively, the camera 36 may include only the hardware needed to view an image, while a memory device of the portable electronic device 10 stores instructions for execution by the processor 20 in the form of software necessary to create a digital image file from a captured image. In an exemplary embodiment, the camera 36 may further include a processing element such as a co-processor which assists the processor 20 in processing image data and an encoder and/or decoder for compressing and/or decompressing image data. The encoder and/or decoder may encode and/or decode according to a JPEG or an MPEG standard format.

The portable electronic device 10 may further include a user identity module (UIM) 38. The UIM 38 is typically a memory device having a processor built in. The UIM 38 may include, for example, a subscriber identity module (SIM), a universal integrated circuit card (UICC), a universal subscriber identity module (USIM), a removable user identity module (R-UIM), etc. The UIM 38 typically stores information elements related to a mobile subscriber. In addition to the UIM 38, the portable electronic device 10 may be equipped with memory. For example, the portable electronic device 10 may include volatile memory 40, such as volatile Random Access Memory (RAM) including a cache area for the temporary storage of data. The portable electronic device 10 may also include other non-volatile memory 42, which can be embedded and/or may be removable. The non-volatile memory 42 can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the portable electronic device 10 to implement the functions of the portable electronic device 10. For example, the memories can include an identifier, such as an international mobile equipment identification (IMEI) code, capable of uniquely identifying the portable electronic device 10.

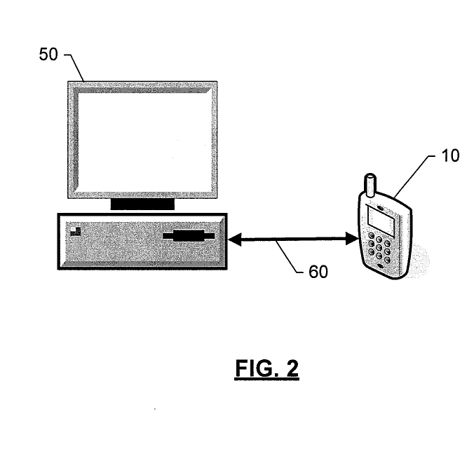

FIG. 2 provides an illustration of one embodiment of the present invention in which the portable electronic device 10 is coupled to a host device 50. The host device 50 is illustrated as a desktop computer, although the host device 50 may be a laptop computer, a network server, a portable electronic device, or any other electronic device capable of receiving and processing information. The host device 50 generally comprises a processor operatively coupled to one or more memory devices, a user interface, and a communication interface. The processor of the host device 50 uses the host device's communication interface to send and/or receive information to and/or from other devices, such as the portable electronic device 10. The communication interface of the host device 50 is communicatively coupled to the communication port 13 of the portable electronic device 10 by connection 60. The connection 60 is generally a wired connection, although the connection 60 may involve a wireless connection, such as a wireless USB connection, a UWB (Ultra Wideband) connection, a Wibree™ connection, and the like. In one embodiment, connection 60 comprises a USB connection having a USB cable 15. The host device 50 includes an OS (Operating System) stored within the host device memory for managing the hardware, software, memory, processes, and other resources of the host device 50. The host device 50 also generally includes at least one BIOS (Basic Input/Output System) for booting the system and for locating and accessing hardware devices such as floppy drives and other disk drives, AT Attachment (ATA) hard disk controllers, USB interfaces, mass storage devices, and the like. The hardware devices, such as disk drives and storage devices typically have associated drivers for interfacing between the operating system and the hardware. The system may or may not permit hot swapping of removable hardware devices.

In general, the portable electronic device 10 has a plurality of data storage medium image files stored in its memory. Each data storage medium image file is comprised of a copy of the content and the structure of a particular data storage medium, such as a particular floppy disk, CD, or DVD. The portable electronic device 10 or some other electronic device may have created the data storage medium image file from the data storage medium by using software and hardware configured for creating image files of storage media. Image creation software and the necessary hardware for creating image files from storage media are well-known. Since the portable electronic device 10 is often designed to be small in size, the portable electronic device 10 will typically not have the requisite hardware to create the image files from the actual storage media. As such, the portable electronic device 10 is often configured to receive data storage media image files from another electronic device via the portable electronic device's communication interface.

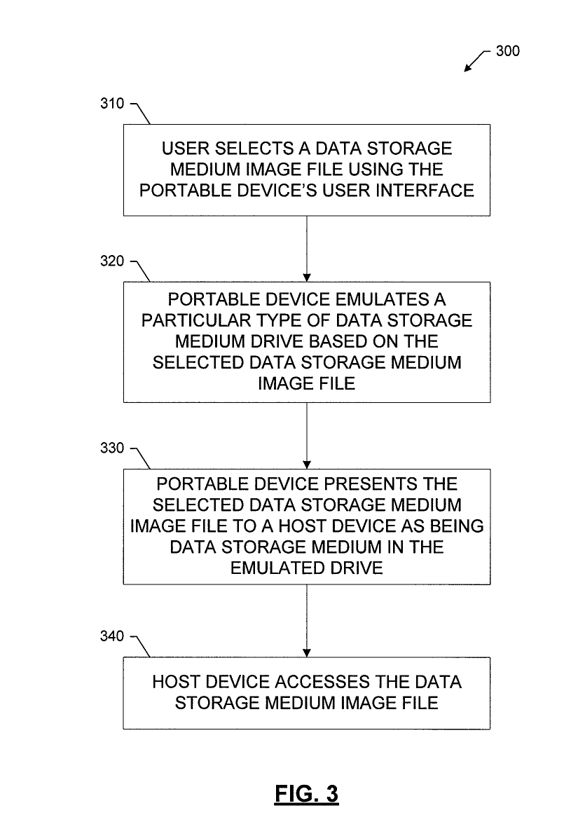

Referring now to FIG. 3, a flowchart is provided illustrating a method 300 of presenting a selected data storage medium image file to a host device in accordance with one embodiment of the present invention. As illustrated by block 310, the user selects a data storage medium image file using the portable electronic device's user interface. For example, the portable electronic device 10 may be configured such that the display 28 of the portable electronic device 10 presents representations of the data storage medium image files stored within the portable electronic device's memory. The user may then select one of the displayed representations in order to indicate that the corresponding data storage medium image file should be presented to the host device 50. The user may select a displayed representation using the user input interface, such as a keypad 30 or a touch screen, of the portable electronic device 10.

After the user selects a particular data storage medium image file for presentation to the host device 50, the portable electronic device 10 may emulate a particular type of data storage medium drive based on the selected data storage medium image file, as illustrated by block 320. In this regard, in one embodiment, the portable electronic device 10 is configured so that it is capable of emulating more than one type of data storage medium drive, such as a floppy disk drive, a CD drive, a DVD drive, a BD drive or other disk drives, hard drives, tape drives, or the like. The user selects the type of drive that the portable electronic device 10 should emulate using the user interface of the portable electronic device 10. As illustrated in FIG. 3, in one embodiment, the user makes such a selection by selecting a particular data storage medium image file stored in the memory of the portable electronic device 10. This selection then indicates to the portable electronic device's processor 20 that the processor 20 should execute software that emulates a data storage medium drive that is of the same type as the selected data storage medium image file. For example, if the user selects a CD-RW image file to be presented to the host device 10, then the portable electronic device 10 may be configured to emulate a CD-RW drive of the host device based on this selection. In response to the emulation, the host device may perform various actions that it would normally perform when a non-virtual hardware device of the selected type is coupled to the host device 50. For example, the host device 50 may allocate a particular block of memory for the hardware device based on the type of the hardware device.

FIG. 3 provides an illustration of one exemplary embodiment of the present invention; however, in other embodiments of the present invention the user may select the type of data storage medium drive in other ways. For example, the user may first select the type of data storage medium drive that the portable electronic device 10 should emulate and, after the user makes such a selection, the user may select an appropriate data storage medium image file to be presented to the host device 50 in the virtual data storage medium drive.

As is generally known in the art, software may be used to emulate a hardware device of a computer, such as a data storage medium drive, so that a virtual data storage medium drive is provided to the computer. The software may provide a virtual driver that interfaces with the BIOS and/or OS of the computer in the same way as a non-virtual hardware device driver would interface with the computer system. In this way, the software may create an illusion for the computer that the computer is interacting with a particular type of hardware, such a local floppy disk drive, and accessing media in that hardware when in reality the computer is accessing files stored in some other type of storage media.

In one embodiment, when the portable electronic device 10 is coupled to the host device 50 via a communication port, such as a USB port, or when the host device 50 is booted with the portable electronic device 10 already coupled to it, the host device 50 recognizes that new hardware is connected at the particular communication port and inquires about the type of hardware device. The portable electronic device 10, using software executed by the processor 20, may respond to this inquiry with an indication of the type of drive that the user instructed the portable electronic device 10 to emulate. If the user has not selected a type of drive that the portable electronic device 10 should emulate, then the portable electronic device may default to a particular type of hardware device, such as a USB mass storage device.

One embodiment of the present invention requires that the host be rebooted when the portable electronic device 10 is first coupled to host device 50 and/or whenever the portable electronic device attempts to change the type of drive that the portable electronic device 10 is emulating. Preferably, however, the host device 50 supports hot swapping of removable hardware devices such that the portable electronic device 10 may be coupled to and uncoupled from a communication interface of the host device 50 without having to restart the host device 50. Furthermore, in one embodiment, where the host device 50 allows for hot swapping of hardware devices, the portable electronic device 10 may more easily switch from one type of virtual drive to a different type of virtual drive. In one embodiment, the portable electronic device 10 may switch the type of virtual drive that it shows to the host device 50 by first uncoupling from the host device 50, then selecting a different type of virtual device, and finally coupling back to the host device 50. For example, the uncoupling and coupling may be effectuated by: the user unplugging/re-plugging a cord from/to a communication port of a device; the portable electronic device 10 itself cutting off communication between the portable electronic device 10 and the host device 50; or the software in the portable electronic device 10 simulating the uncoupling and re-coupling of the portable electronic device 10 or the virtual drive. These hot swapping issues may be more of an issue with regard to the embodiment of the invention where the portable electronic device 10 is only capable of emulating one drive of the host device 50 at a time. In other embodiments of the system, however, the portable electronic device 10 may be configured to simultaneously emulate more than one drive of the host device 50.

As illustrated by block 330, as the portable electronic device 10 emulates the data storage medium drive, the portable electronic device 10 presents the selected data storage medium image file to the host device 50 in the virtual data storage medium drive. As such, the selected data storage medium image file appears to the host device 50 as being a non-virtual data storage medium in a non-virtual data storage medium drive of the host device 50. For example, on a Windows-based device, a CD-ROM image file presented in a virtual CD-ROM drive may be shown as a non-virtual CD-ROM in a non-virtual CD-ROM drive of the host device 50 if the user clicks on the “My Computer” icon and views the list of local drives of the host device 10. Likewise, in a Windows-based environment or similar environments, the auto-run feature of Windows (if enabled) may automatically run, for example, the setup.exe program in the root directory of the CD-ROM image file. In this way, the host device 50 may access the data storage medium image file, as illustrated by block 340. The host device 50 may access the data storage medium image file by reading from and/or writing to the image file. The host device 50 may also access the image file by executing a program contained in the image file.

Therefore, it should be appreciated that embodiments of the present invention may permit a user to have a portable electronic device 10 that contains a plurality of data storage medium image files stored therein. The user may couple the portable electronic device 10 to a host device 50 and emulate a local drive of the host device 50 so that the host device 50 may access the content in the image file on the portable electronic device 10 such that it appears to the host device 50 that the host device is accessing the content on a data storage medium contained in a non-virtual data storage medium drive. It should be appreciated that, in general, embodiments of the present invention do not require any modifications to the host device 50 if the host device 50 has a communication port and a standard operating system. Embodiments of the present application may be particularly useful to a system or network administrator for installing software, such as firmware or OS updates, where the host device requires that the system boot from a particular drive and where the installation requires the administrator to use several disks to install the software.

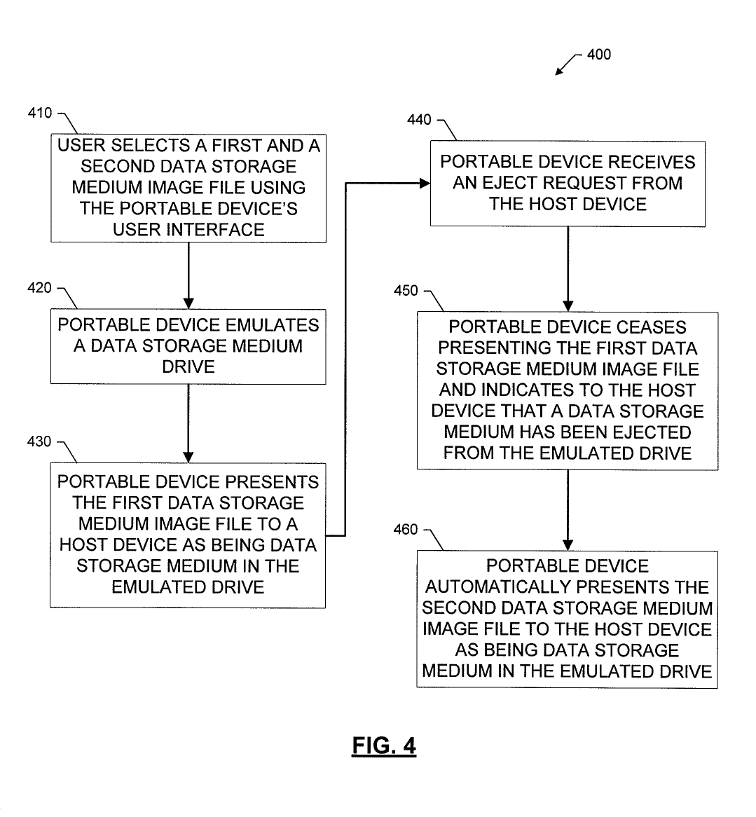

Referring now to FIG. 4, a flowchart is provided of a method 400 of presenting more than one selected data storage medium image file to a host device in accordance with one embodiment of the present invention. As illustrated by block 410, the user may select a plurality of storage medium image files stored in the portable electronic device 10 using the portable electronic device's user interface. For example, the user may select a first data storage medium image file and a second data storage medium image file. The user may also input a particular order that the data storage medium image files should be presented to the host device 50.

As described above and as illustrated by block 420, the portable electronic device 10 may emulate a data storage medium drive of the host device 50 and thereby provide the host device with access to a virtual data storage medium drive. As illustrated by block 430, the portable electronic device 10 may then present the first data storage medium image file to the host device as being in the virtual data storage medium drive. In this way, the host device may access the data storage medium image file stored in the portable electronic device's memory.

As illustrated by the block 440, the portable electronic device 10 may receive an eject request, such as a eject command, from the host device 50 instructing the virtual data storage medium driver to eject the current data storage medium image file. For example, the host device 50 may be executing an installation program which may require that the user eject the current installation disk in a disk drive of the host device 50 and insert a different installation disk in the disk drive. In another example, the user of the host device instructs the host device to eject the current disk in a drive of the host device. The host device 50, considering the virtual data storage medium drive to be a non-virtual drive having a removable medium stored therein, the host device 50 communicates the eject request to the drive. Software on the portable electronic device 10, such as a virtual driver, receives the eject request.

In response the eject request, the portable electronic device 10 may cease presenting the first data storage medium image file to the host device, as illustrated by block 450. The portable electronic device 10 may then simulate an ejection of the media by communicating to the host device 50 that a data storage medium was ejected from the data storage medium drive, as also illustrated by block 450. The software on the portable electronic device 10 is configured to communicate this information to the host device 50 in the same way that an actual drive would communicate such information.

In the illustrated embodiment of the invention, where the user has selected more than one data storage medium image file for presentment to the host device, the portable electronic device 10 may be configured to automatically present the next (here the second) data storage medium image file to the host device 50 as being a new storage medium in the emulated drive, as illustrated by block 460. The host device 50 may then access the second data storage medium image file.

The functions described above with respect to the various embodiments of the present invention may be carried out in many ways. For example, any suitable means for carrying out each of the functions described above may be employed to carry out embodiments of the invention. According to one aspect of the present invention, all or a portion of the system of the present invention generally operates under control of a computer program product. The computer program product for performing the various processes and operations of embodiments of the present invention includes a computer-readable storage medium, such as a non-volatile storage medium, and computer-readable program code portions, such as a series of computer instructions, embodied in the computer-readable storage medium. For example, in one embodiment, the respective processors of the portable electronic device and host device generally execute a one or more applications in order to perform the various functions described above with reference to the portable electronic device and host device, such as those shown in conjunction with FIGS. 3 and 4.

In this regard, FIGS. 3 and 4 are flowcharts or block diagrams of methods, systems, devices, and computer program products according to embodiments of the present invention. It will be understood that each block of a flowchart or each step of a described method can be implemented by computer program instructions. These computer program instructions may be loaded onto a computer or other programmable apparatus to produce a machine, such that the instructions which execute on the computer or other programmable apparatus create means for implementing the functions specified in the described block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the described block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the described block(s) or step(s).

It will also be understood that each block or step of a described herein, and combinations of blocks or steps, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A portable electronic device comprising:
a memory for storing a data storage medium image file, the data storage medium image file comprising a copy of content and structure of a data storage medium;
a user interface for allowing a user to enter user input;
a data communication interface for communicatively coupling the portable electronic device to a host device; and
a processor operatively coupled to the memory, the user interface, and the data communication interface, wherein the processor is configured to provide the host device with a virtual data storage medium drive that allows the host device to access the data storage medium image file; wherein the processor is configured to provide the virtual data storage medium drive when the user input instructs the processor to do so.

2. The portable electronic device of claim 1, wherein the processor is configured to provide at least two types of virtual data storage medium drives, and wherein the processor is configured to provide one of the at least two types based on the user input.

3. The portable electronic device of claim 2, wherein the types of virtual data storage medium drives comprise a floppy disk drive, a CD-ROM drive, a CD-R/RW drive, a DVD drive, a DVD±R drive, and a DVD±RW drive.

4. The portable electronic device of claim 2, wherein the memory is configured to store at least two types of data storage medium image files, wherein the user input interface is configured to allow the user to select a data storage medium image file, and wherein the processor provides the one of the at least two types of virtual data storage medium drives based on the type of the selected data storage medium image file.

5. The portable electronic device of claim 1, wherein the user input interface is configured to allow the user to select a data storage medium image file stored in the memory for presentation to the host device, and wherein the processor is configured to provide the virtual data storage medium drive when the user selects the data storage medium image file for presentation to the host device.

6. The portable electronic device of claim 1, wherein the memory comprises a virtual driver stored therein, wherein the processor is configured to provide the virtual data storage medium drive by executing the virtual driver, and wherein the processor executing the driver is configured to allow the host device to access the data storage medium image file in the same way that the host device would access a data storage medium in a non-virtual data storage medium drive.

7. The portable electronic storage device of claim 1, wherein the processor is configured to receive an ejection request from the host device and is configured to provide a response to the host device that a data storage medium has been ejected.

8. The portable electronic device of claim 7, wherein the user input comprises a selection of a first data storage medium image file and a second data storage medium image file stored in the memory; wherein the processor is configured to present the first data storage medium image file to the host device as being in the virtual data storage medium drive; and wherein the processor, in response to the ejection request from the host device, is further configured to cease presenting the first data storage medium image file as being in the virtual data storage medium drive and automatically commence presenting of the second data storage medium image file in the virtual data storage medium drive.

9. The portable electronic device of claim 1, wherein the data communication interface comprises a USB port for communicatively coupling the portable electronic device to the host device.

10. The portable electronic device of claim 1, wherein the data communication interface comprises a wireless transceiver for wirelessly coupling the portable electronic device to the host device.

11. The portable electronic device of claim 1, wherein the portable electronic device comprises a mobile telephone.

12. The portable electronic device of claim 1, wherein the user interface is a local interface.

13. A computer program product for emulating a data storage medium drive of a host device on a portable electronic device when the portable electronic device is operatively coupled to the host device, the computer program product comprising at least one computer-readable storage medium having computer-readable program code portions stored therein, the computer-readable program code portions comprising:
a first executable portion for receiving user input comprising an indication that a virtual data storage medium drive should be provided to the host device; and
a second executable portion for providing the host device with the virtual data storage medium drive and for presenting a data storage medium image file to the host device in the virtual data storage medium drive, wherein the data storage medium image file comprises a copy of content and structure of a data storage medium, and wherein the second executable portion is configured to provide the virtual data storage medium drive based on the user input received by the first executable portion.

14. The computer program product of claim 13, wherein the second executable portion is configured to provide at least two types of virtual data storage medium drives, and wherein the second executable portion is further configured to provide one of the at least two types of virtual data storage medium drives based on the user input.

15. The computer program product of claim 14, wherein the types of virtual data storage medium drives comprise a floppy disk drive, a CD drive, and a DVD drive.

16. The computer program product of claim 14, wherein the first executable portion is configured to receive user input comprising a selection of a data storage medium image file, and wherein the second executable portion is configured to provide the one of the at least two types of virtual data storage medium drives based on the type of the selected data storage medium image file.

17. The computer program product of claim 13, wherein first executable portion is configured to receive user input comprising a selection of a data storage medium image file for presentation to the host device, and wherein the second executable portion is configured to provide the virtual data storage medium drive upon the first executable portion receiving the selection of a data storage medium image file for presentation to the host device.

18. The computer program product of claim 13, further comprising a virtual driver, wherein the second executable portion is configured to provide the virtual data storage medium drive using the virtual driver to provide an illusion to the host device that the host device is interfacing with a non-virtual data storage medium drive.

19. The computer program product of claim 13, wherein the second executable portion is configured to receive an ejection request from the host device and is configured to provide a response to the host device that a data storage medium has been ejected.

20. The computer program product of claim 19, wherein the first executable portion is configured to receive user input comprising a selection of a first data storage medium image file and a second data storage medium image file stored in the portable electronic device; wherein the second executable portion is configured to present the first data storage medium image file to the host device as being in the virtual data storage medium drive; and wherein the second executable portion, in response to the ejection request from the host device, is further configured to cease presenting the first data storage medium image file as being in the virtual data storage medium drive and automatically commence presenting of the second data storage medium image file in the virtual data storage medium drive.

21. The computer program product of claim 13, further comprising a third executable portion for interfacing with the host device using a USB standard.

22. The computer program product of claim 13, wherein the computer program product is configured to be executed by a processor of a mobile telephone.

23. A method of using a portable electronic device to emulate a data storage medium drive of a host device, the method comprising:
receiving, at the portable electronic device, user input comprising an indication that a virtual data storage medium drive should be provided to the host device;
providing the host device with a virtual data storage medium drive based on the user input; and
presenting a data storage medium image file to the host device in the virtual data storage medium drive, wherein the data storage medium image file comprises a copy of content and structure of a data storage, medium.

24. The method of claim 23 further comprising:
providing the user with an option of selecting at least two types of virtual data storage medium drives; and
providing one of the at least two types of virtual data storage medium drives based on the user input.

25. The method of claim 24, wherein the types of virtual data storage medium drives comprise a floppy disk drive, a CD drive, and a DVD drive.

26. The method of claim 24, further comprising:
receiving user input comprising a selection of a data storage medium image file; and
providing the one of the at least two types of virtual data storage medium drives based on the type of the selected data storage medium image file.

27. The method of claim 23, further comprising:
receiving user input comprising a selection of a data storage medium image file for presentation to the host device; and
providing the virtual data storage medium drive upon receipt of the selection of a data storage medium image file for presentation to the host device.

28. The method of claim 23, further comprising:
providing the virtual data storage medium drive using a virtual driver to provide an illusion to the host device that the host device is interfacing with a non-virtual data storage medium drive.

29. The method of claim 23, further comprising:
receiving an ejection request from the host device; and
providing a response to the host device that a data storage medium has been ejected.

30. The method of claim 29, further comprising:
receiving user input comprising a selection of a first data storage medium image file and a second data storage medium image file stored in the portable electronic device;
presenting the first data storage medium image file to the host device as being in the virtual data storage medium drive; and
in response to the ejection request from the host device:
ceasing presentment of the first data storage medium image file as being in the virtual data storage medium drive; and
automatically commencing presentment of the second data storage medium image file in the virtual data storage medium drive.

31. The method of claim 23, further comprising:
interfacing with the host device using a USB standard.

32. The method of claim 23, wherein the portable electronic device comprises a mobile telephone.

33. A portable electronic device configured to emulate a data storage medium drive of a host device, the portable electronic device comprising:
means for receiving, at the portable electronic device, user input comprising an indication that a virtual data storage medium drive should be provided to the host device;
means for providing the host device with a virtual data storage medium drive based on the user input; and
means for presenting a data storage medium image file to the host device in the virtual data storage medium drive, wherein the data storage medium image file comprises a copy of content and structure of a data storage medium.

34. The portable electronic device of claim 33 further comprising:
means for providing the user with an option of selecting at least two types of virtual data storage medium drives; and
means for providing one of the at least two types of virtual data storage medium drives based on the user input.
